(19) United States
(12) Patent Application Publication
(10) Pub. No.: US 2026/0277784 A1
(43) Pub. Date: Sep. 17, 2026

(54) MATRIX COMPRESSION AND TRAVERSAL METHOD AND ELECTRONIC DEVICE THEREOF

(71) Applicant: SAMSUNG ELECTRONICS CO., LTD., Suwon-si (KR)

(72) Inventor: Hyeonuk SIM, Suwon-si (KR)

(73) Assignee: SAMSUNG ELECTRONICS CO., LTD., Suwon-si (KR)

(21) Appl. No.: 19/343,777

(22) Filed: Sep. 29, 2025

(30) Foreign Application Priority Data
Mar. 17, 2025 (KR) 10-2025-0034212

(51) Int. Cl. G06F 12/02

(52) U.S. Cl. CPC G06F 12/0207; G06F 2212/401

(57) ABSTRACT

A method of storing a compressed matrix, including: identifying a plurality of non-zero data elements in an input matrix and generating a data array in which the plurality of non-zero data elements are arranged sequentially; generating a pointer corresponding to each row or each column of the input matrix; designating, to the pointer, a position in the input matrix or a number of non-zero data elements included in a corresponding row or column, wherein the pointer includes at least one of a row pointer and a column pointer; generating an offset indicating a relative interval between the plurality of non-zero data elements; and designating, to the offset, a relative index in a row or column direction, wherein the offset includes at least one of a row offset and a column offset; generating a compressed matrix; and storing the compressed matrix in at least one memory.

### CROSS-REFERENCE TO RELATED APPLICATION

This application is based on and claims priority under 35 U.S.C. §119 to Korean Patent Application No. 10-2025-0034212, filed on Mar. 17, 2025, in the Korean Intellectual Property Office, the disclosure of which is incorporated by reference herein in its entirety.

### BACKGROUND

### 1. Field

The present disclosure relates to a matrix compression and traversal method, and an electronic device for performing matrix compression and traversal.

### 2. Description of the Related Art

A sparse matrix may refer to a matrix in which most elements have a value of zero (“0”). The sparse matrix may be used in various fields such as machine learning, signal processing, graph algorithms, data compression, optimization issues, and the like. When storing and operating the sparse matrix, memory usage may be reduced and operation speed may be improved by using a special data structure that targets only non-zero elements (e.g., elements having values other than zero (“0”)).

A sparse matrix representation method may be useful for efficiently performing matrix operations. For example, various optimization techniques may be applied to maximize memory bandwidth and computational efficiency in sparse matrix-vector multiplication (SpMV) or sparse matrix-matrix multiplication (SpMM).

### SUMMARY

One or more embodiments may address at least the above problems and/or disadvantages and other disadvantages not described above. Also, the embodiments are not required to overcome the disadvantages described above, and an embodiment may not overcome any of the problems described above.

In accordance with an aspect of the disclosure, a method of storing a compressed matrix includes: obtaining an input matrix including a plurality of data elements; identifying a plurality of non-zero data elements in the input matrix and generating a data array in which the plurality of non-zero data elements are arranged sequentially; generating a pointer corresponding to each row from among a plurality of rows included in the input matrix, or corresponding to each column from among a plurality of columns included in the input matrix; designating, to the pointer, a position in the input matrix or a number of non-zero data elements included in a corresponding row from among the plurality of rows, or included in a corresponding column from among the plurality of columns, wherein the pointer includes at least one of a row pointer and a column pointer; generating an offset that indicates a relative interval between the plurality of non-zero data elements; and designating, to the offset, a relative index for traversing the input matrix in a row direction or a column direction, wherein the offset includes at least one of a row offset and a column offset; generating a compressed matrix corresponding to the input matrix based on the data array, the pointer, and the offset; and storing the compressed matrix in at least one memory.

The offset may include a predetermined bitwidth.

The method may further include: based on an interval between adjacent non-zero data elements in the input matrix exceeding a range that is capable of being expressed using the predetermined bitwidth, inserting a value of zero (“0”) to the offset .

The pointer may include information regarding a data index assigned to each non-zero data element, and the information regarding the data index may include: for the each row or the each column, information indicating an initial data index corresponding to the each row or the each column, and a final data index corresponding to the each row or the each column.

The storing of the compressed matrix may include: storing the pointer in a pointer memory corresponding to the pointer; storing the offset in an offset memory corresponding to the offset; and placing the data array in a data memory separate from the pointer memory and the offset memory.

In accordance with an aspect of the disclosure, a method of traversing a compressed matrix includes: obtaining a data array corresponding to a compressed matrix from at least one memory; obtaining, from the at least one memory, a pointer and an offset corresponding to the compressed matrix, wherein the pointer includes at least one of a row pointer and a column pointer, and wherein the offset includes at least one of a row offset and a column offset; obtaining a data index corresponding to a non-zero data element included in the data array based on an offset corresponding to a traversal direction, a pointer corresponding to the traversal direction, and a pointer corresponding to a direction different from the traversal direction; obtaining a value corresponding to the non-zero data element based on the data index; and reconstructing at least a portion of a decompressed matrix corresponding to the compressed matrix based on the value.

The method may further include: based on determining that the data index corresponding to the non-zero data element in the data array is obtained, updating a pointer value corresponding to the data index.

The method may further include: after identifying the data index based on a pointer corresponding to the traversal direction, determining a position of a corresponding data element in the decompressed matrix by referencing the offset corresponding to the traversal direction according to the data index.

The pointer value may be updated by incrementing a corresponding data index for each iteration such that the pointer corresponding to the traversal direction subsequently indicates a next non-zero data element included in the data array.

The pointer value may be updated by storing a current index of a corresponding pointer in a separate buffer, and increasing a value stored in the separate buffer by a value of one (“1”) based on an index corresponding to non-zero data being identified.

In accordance with an aspect of the disclosure, an electronic device configured to perform at least one of matrix compression and matrix traversal, the electronic device including: one or more processors; and memory configured to store instructions which, when executed by the one or more processors, individually or collectively, cause the electronic device to: obtain an input matrix including a plurality of data elements; identify a plurality of non-zero data elements in the input matrix and generate a data array in which the plurality of non-zero data elements are arranged sequentially; generate a pointer corresponding to each row from among a plurality of rows included in the input matrix, or corresponding to each column from among a plurality of columns included in the input matrix, designate, to the pointer, a position in the input matrix or a number of non-zero data elements included in a corresponding row from among the plurality of rows, or included in a corresponding column from among the plurality of columns, wherein the pointer includes at least one of a row pointer and a column pointer; and generate an offset that indicates a relative interval between the plurality of non-zero data elements, and designate, to the offset, a relative index for traversing the input matrix in a row direction or a column direction, wherein the offset includes at least one of a row offset and a column offset, generate a compressed matrix corresponding to the input matrix based on the data array, the pointer, and the offset; and store the compressed matrix in at least one memory.

The offset may include a predetermined bitwidth.

The instructions, when executed by the one or more processors, individually or collectively, may further cause the electronic device to: based on an interval between adjacent non-zero data elements in the input matrix exceeding a range that is capable of being expressed using the predetermined bitwidth, inserting a value of zero (“0”) to the offset.

The pointer may include information regarding a data index assigned to each non-zero data elements, and the information regarding the data index may include: for the each row or the each column , information indicating an initial data index corresponding to the each row or the each column, and a final data index corresponding to the each row or the each column.

The instructions, when executed by the one or more processors, individually or collectively, may further cause the electronic device to: store the pointer in a pointer memory corresponding to the pointer, store the offset in an offset memory corresponding to the offset; and place the data array in a data memory separate from the pointer memory and the offset memory.

The instructions, when executed by the one or more processors, individually or collectively, may further cause the electronic device to: obtain the data array corresponding to the compressed matrix from the at least one memory; obtain the pointer and the offset corresponding to the compressed matrix; obtain a data index corresponding to a non-zero data element included in the data array based on an offset corresponding to a traversal direction, a pointer corresponding to the traversal direction, and a pointer corresponding to a direction different from the traversal direction; obtain a value corresponding to the non-zero data element based on the obtained data index; and reconstruct at least a portion of a decompressed matrix corresponding to the compressed matrix based on the value.

The instructions, when executed by the one or more processors, individually or collectively, may further cause the electronic device to: based on determining that the data index corresponding to the non-zero data element in the data array is obtained, a pointer value corresponding to the data index.

The instructions, when executed by the one or more processors, individually or collectively, may further cause the electronic device to: after identifying the data index based on a pointer corresponding to the traversal direction, determine a position of a corresponding data element in the decompressed matrix by referencing the offset corresponding to the traversal direction according to the data index.

The instructions, when executed by the one or more processors, individually or collectively, may further cause the electronic device to: wherein the pointer value is updated by incrementing a corresponding data index for each iteration such that the pointer corresponding to the traversal direction subsequently indicates a next non-zero data element included in the data array.

The instructions, when executed by the one or more processors, individually or collectively, may further cause the electronic device to: update the pointer value by storing a current index of a corresponding pointer in a separate buffer, and increase a value stored in the separate buffer by a value of one (“1”) based on an index corresponding to non-zero data being identified.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a flowchart illustrating a matrix compression process according to an embodiment;

FIG. 2 is a flowchart illustrating a matrix traversal process according to an embodiment;

FIG. 3 is a diagram schematically illustrating a compressed sparse row (CSR) according to an embodiment;

FIG. 4 is a diagram schematically illustrating a matrix compression process according to an embodiment;

FIG. 5 is an example diagram illustrating a matrix traversal process according to an embodiment;

FIG. 6 is a flowchart illustrating a matrix compression algorithm according to an embodiment;

FIG. 7 is a flowchart illustrating a row-wise traversal algorithm for a matrix, according to an embodiment;

FIG. 8 is a block diagram schematically illustrating an electronic device configured to perform a traverse operation, according to an embodiment; and

FIG. 9 is a block diagram illustrating an electronic device according to an embodiment.

### DETAILED DESCRIPTION

The following detailed structural or functional description is provided as an example only and various alterations and modifications may be made to the embodiments without departing from the scope of the disclosure. Thus, an actual form of implementation should not be construed as being limited to the particular embodiments described herein, and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly, the second component may also be referred to as the first component.

It should be noted that when one component is described as being "connected," "coupled," or "joined" to another component, the first component may be directly connected, coupled, or joined to the second component, or a third component may be "connected," "coupled," or "joined" between the first and second components.

The singular forms "a," "an," and "the" are intended to include the plural forms as well, unless the context clearly indicates otherwise. It will be further understood that the terms "comprises/comprising" and/or "includes/including" when used herein, specify the presence of stated features, integers, steps, operations, elements, and/or components, but do not preclude the presence or addition of one or more other features, integers, steps, operations, elements, components and/or groups thereof.

As used herein, each of phrases such as "A or B," "at least one of A and B," "at least one of A or B," "A, B, or C," "at least one of A, B, and C," and "at least one of A, B, or C" may include any one of the items listed in the corresponding one of the phrases or all possible combinations thereof. For example, expressions such as “at least one of”, when preceding a list of elements, modify the entire list of elements and do not modify the individual elements of the list. As an example, the expressions "at least one of A, B, or C" and "at least one of A, B, and C" should be understood as including only "A", only "B", only "C", both "A and B", both "A and C", both "B and C", "all of A, B, and C", or any other variations thereof.

Unless otherwise defined, all terms used herein including technical and scientific terms have the same meanings as those commonly understood by one of ordinary skill in the art to which this disclosure pertains. Terms such as those defined in commonly used dictionaries are to be interpreted as having a meaning that is consistent with their meaning in the context of the relevant art and are not to be interpreted in an idealized or overly formal sense unless expressly so defined herein.

Embodiments may be implemented as, or included in, various types of products such as, for example, a personal computer, a laptop computer, a tablet computer, a smart phone, a television, a smart home appliance, an intelligent vehicle, a kiosk, and a wearable device. Hereinafter, embodiments are described in detail with reference to the accompanying drawings. When describing the embodiments with reference to the accompanying drawings, like reference numerals refer to like components and a repeated, redundant, or duplicative description related thereto may be omitted.

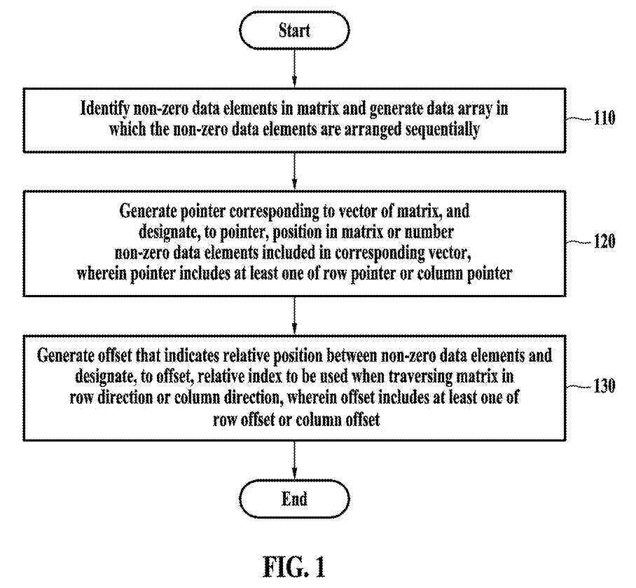

FIG. 1 is a flowchart illustrating a matrix compression process according to an embodiment.

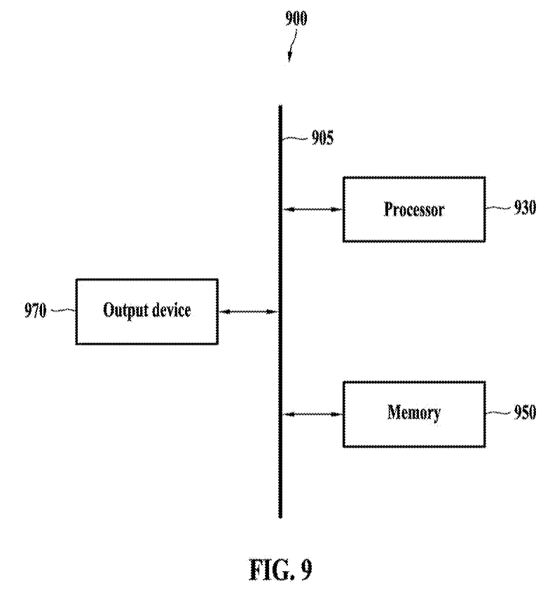

For ease of description, the operations illustrated in FIG. 1 are described as being performed using an electronic device 900 illustrated in FIG. 9, but embodiments are not limited thereto. For example, one or more of the operations illustrated in FIG. 1 may also be performed by another suitable electronic device in a suitable system.

Furthermore, the operations illustrated in FIG. 1 may be performed in the order and manner in which they are illustrated, but embodiments are not limited thereto. For example, the order of some operations may change, or some operations may be omitted without departing from the spirit and scope of the disclosure. The operations shown in FIG. 1 may be performed in parallel or simultaneously.

A sparse matrix may refer to a matrix in which most elements have a value of zero ("0”). When processing a sparse matrix, it may be beneficial to store and utilize only non-zero elements of the matrix (e.g., elements which have a value that is not zero (“0”). Some approaches to sparse matrix representation may include a compressed sparse row (CSR) approach, a compressed sparse column (CSC) approach, and a coordinate list (COO) approach.

The CSR approach may store the non-zero elements consecutively in units of rows (e.g., row by row), and may store, in a separate array, an index of a first non-zero element in each row. In the CSR approach, memory access efficiency may be improved when the stored matrix is accessed sequentially in a row direction.

The CSC approach may be similar to the CSR approach but may include storing the non-zero elements in units of columns (e.g., column by column).

The COO approach may include storing coordinates (e.g., rows, columns) and values of the non-zero elements separately.

However, embodiments described below are applicable to sparse matrices, and may also be applied to dense matrices. Examples are described below which relate to sparse matrices for ease of description, but embodiments are not limited thereto.

Matrix operations may include operations such as sparse matrix-vector multiplication (SpMV), sparse matrix-matrix multiplication (SpMM), and the like. To optimize matrix operations, a computational technique may be applied which considers a data structure and an access method on hardware accelerators (e.g., a neural processing unit (NPU), a graphics processing unit (GPU), and a field-programmable gate array (FPGA)).

A pointer may point to a position in a data array, for example a position in the data array at which a particular row or column of a matrix begins. A row pointer may indicate a position, in each row, at which a non-zero element begins. A column pointer may indicate a position, in each column, at which a non-zero element begins. A pointer may not store data directly, and instead may provide an index to reference a specific element in the data array.

An offset may indicate a relative position or interval between the non-zero elements within the data array. A row offset may indicate an interval between non-zero elements within a same row, and a column offset may indicate an interval between non-zero elements within a same column.

The data array may consecutively store only the non-zero elements, thereby reducing memory usage compared to an approach that includes storing an entire matrix. Matrix operation speed may be improved by accessing the data sequentially using the data array.

In a process of compressing a matrix, a data array may be organized based on a specific row or column. After the data array is generated, information about a starting position of each row or each column may be stored in a pointer, and information about the relative position or interval between the non-zero elements may be stored in an offset.

When traversing a matrix, a position of a non-zero element in the data array may be determined by referencing the pointer and the offset. For example, when traversing the matrix in the row direction, the starting position may be set based on the row pointer, and data may be extracted by following the row offset (e.g., according to the row offset). When traversing the matrix in a column direction, the starting position may be set based on the column pointer, and data may be extracted by following the column offset (e.g., according to the column offset).

Hereinafter, an example of a matrix compression process is described in detail.

At operation 110, the electronic device 900 may identify a plurality of non-zero data elements included in a matrix (e.g., a sparse matrix) and may generate a data array in which a corresponding plurality of non-zero data elements are arranged sequentially. In embodiments, the plurality of non-zero data elements may be referred to as a plurality of pieces of non-zero data. For example, each non-zero data element included in the plurality of non-zero data elements may be referred to as a piece of non-zero data included in the plurality of pieces of non-zero data. In embodiments, the plurality of non-zero data elements may be referred to as a plurality of non-zero elements of the matrix. For example, each non-zero data element included in the plurality of non-zero data elements may be referred to as a non-zero element included in the plurality non-zero elements.

The electronic device 900 may sequentially identify all elements of the matrix to determine a position and a value of each non-zero data element. After indices of rows and columns containing or including non-zero data elements are identified, those non-zero data elements may be organized in a format or structure that is different from the matrix.

The electronic device 900 may generate the data array by arranging the identified non-zero data elementsin a consecutive memory space. The data array may be, or may include, a structure that contains or includes only non-zero data within a matrix, and may be configured so that only elements that are a target of an operation may be accessed during a matrix operation.

For example, the electronic device 900 may place the data element in a consecutive index of a new array based on determining that a value of the data element in the matrix is non-zero (e.g., has a value other than zero (“0”)). The above process may optimize a memory access pattern by storing data in a format of a one-dimensional array.

The electronic device 900 may facilitate subsequent data reference and operations by sequentially arranging the plurality of non-zero data elements. In particular, by arranging the data array in a determined order (e.g. row-wise or column-wise), an operation in a particular direction may be optimized.

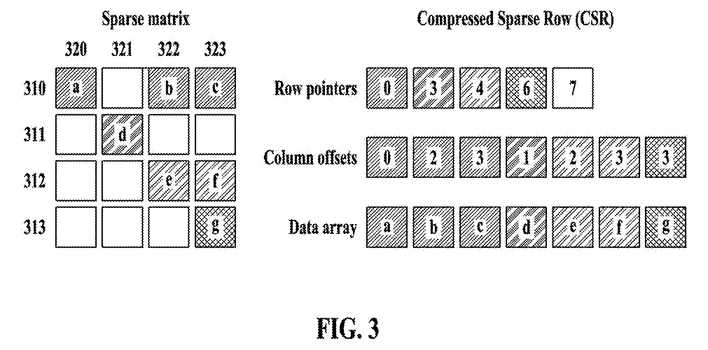

For example, the electronic device 900 may configure the data array using the CSR format. In the CSR format, a data array storing only values of non-zero elements, a column index array storing column indices corresponding to the non-zero elements, and a row pointer array indicating a point at which each row begins may be created. An example of the CSR format is described in detail with reference to FIG. 3.

At operation 120, the electronic device 900 may generate a pointer corresponding to each vector from among a plurality of vectors included in the matrix. In embodiments, the plurality of vectors may correspond to a plurality of columns included in the matrix or a plurality of rows of the matrix. For example, each vector from among the plurality of vectors may correspond to a row from among the plurality of rows, or may correspond to a column from among the plurality of columns. . In addition, the electronic device 900 may designate, to the pointer, a position in the matrix or the number of non-zero data elements contained or included in a corresponding vector from among the plurality of vectors (e.g., a corresponding row from among the plurality of rows, or a corresponding column from among the plurality of columns). According to embodiments, the pointer may include at least one of a row pointer and a column pointer.

The pointer may include information regarding a data index assigned to each of the data elements. For example, the information regarding the data index may include, for each of the rows or each of the columns of the matrix, information from an initial data index to a final data index indicating non-zero data.

At operation 130, the electronic device 900 may generate an offset indicating a relative position or interval (e.g., distance) between the non-zero data elements and designate, to the offset, a relative index to be used when traversing in the row direction or the column direction. The offset may obtain at least one of the row offset and the column offset.

For example, the electronic device 900 may compress a matrix based on the CSR format and the CSC format for row-wise traversal. The electronic device 900 may generate, based on the CSR format, a column pointer that stores the number of non-zero data elements included in each column, a row pointer that stores the data index existing in each row, and a relative row index (or a relative row offset) that indicates the relative position between data elements in each row. Here, because the relative position value of the relative row index cannot be a value of zero (“0”), a value of the relative position negative one (“- 1”) may be stored.

The offset may include a predetermined bitwidth. When an interval between adjacent non-zero data elements in the matrix exceeds a range that may be expressed by the bitwidth, the electronic device 900 may record a corresponding interval by inserting a value of zero ("0") to the offset. For example, when the bitwidth is four bits (which may correspond to a maximum expressible value of fifteen (“15”)) and when an interval of sixteen (“16”) or more needs to be expressed, a value of zero (“0”) may first be stored additionally, and the remaining offset value may be recorded separately.

The electronic device 900 may store the pointer and the offset in respective memories, and may store or place the data array in a separate memory space (e.g., a memory that is different from one or more memories that may be used to store the pointer and the offset.

For example, in a hardware implementation according to some embodiments, the data array, the pointer, and the offset may be stored in respective memory areas, and a matrix operation may be accelerated using parallel processing. To optimize a data access pattern, the electronic device 900 may perform a memory access based on the row pointer or the column pointer.

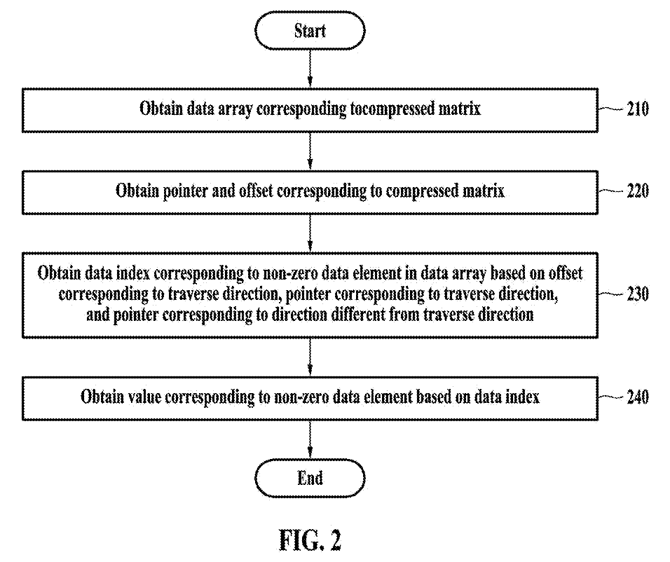

FIG. 2 is a flowchart illustrating a matrix traversal process according to an embodiment.

The description provided with reference to FIG. 1 may apply to FIG. 2, and any repeated description, redundant, or duplicative related thereto may be omitted.

For ease of description, operations 210 to 240 are described as being performed using the electronic device 900 illustrated in FIG. 9. However, operations 210 to 240 may also be performed by another suitable electronic device in a suitable system.

Furthermore, although the operations of FIG. 2 may be performed in the shown order and manner, the order of some of the operations may be changed, or some of the operations may be omitted without departing from the spirit and scope of the shown embodiment. The operations shown in FIG. 2 may be performed in parallel or simultaneously.

At operation 210, the electronic device 900 may obtain a data array. The data array may include a structure that extracts only non-zero data from a matrix and stores the non-zero data consecutively. The electronic device 900 may directly reference only non-zero elements through the data array.

At operation 220, the electronic device 900 may obtain a pointer and an offset that store information regarding the data array. The pointer may indicate positions of non-zero data elements contained or included in a particular row or column in the matrix, and the offset may indicate a relative distance between non-zero data elements within a same row or a same column. The pointer may include at least one of a row pointer and a column pointer, and the offset may include at least one of a row offset and a column offset.

The electronic device 900 may load the pointer and the offset from respective memory areas and access the data separately from the data array. The pointer may be used to quickly find a determined position in the data array, and the offset may be used to compute a relative position between the non-zero data elements.

At operation 230, the electronic device 900 may obtain a data index corresponding to a non-zero data element in the data array based on an offset (e.g., a row offset) corresponding to a traversal direction (e.g., a row direction), a pointer (e.g., a row pointer) corresponding to the traversal direction, and a pointer (e.g., a column pointer) corresponding to a direction different from (e.g., a direction other than) the traversal direction.

For example, when the traversal direction is row-wise (e.g., a row direction), the electronic device 900 may determine, by referencing the row pointer, a position in a current row at which the non-zero data begins (e.g., at which the non-zero data elements begin).

The electronic device 900 may, based on the data index corresponding to the non-zero data element in the data array being obtained, update a pointer value pointing to the corresponding data index.

The electronic device 900 may, after identifying a data index of a non-zero data element pointed to by the pointer corresponding to the traversal direction, determine a position of the non-zero data element in the matrix by referencing the offset corresponding to the traversal direction according to the data index. For example, during row-wise traversal, a relative position of each data element (e.g., each non-zero data element) may be determined by sequentially accumulating row offsets, starting from a position pointed to by the row pointer. When traversing the matrix in the row direction, the electronic device 900 may determine, based on the row pointer, a position in each row at which a non-zero data element is stored, and may subsequently determine an index of next data (e.g., an index of a next non-zero data element) by referencing the row offset.

The electronic device 900 may update the pointer value by increasing the data index by an index value of one (“1”) or more for each iteration when updating the pointer value so that the pointer may subsequently point to next a non-zero data element included in the data array. As the pointer value is updated, the electronic device 900 may identify an exact position of the data element even during an iterative traversing process, and may facilitate a sequential access to the data elements included in the data array.

The electronic device 900 may store a current index of the corresponding pointer in a separate buffer, and may increase a value stored in the buffer by a value of one (“1”) each time an index corresponding to a non-zero data element is identified, one at a time. For example, when traversing the matrix in the row direction, when the pointer points to a first non-zero data element included in a particular row, the electronic device 900 may track a position of a next non-zero data element by increasing a pointer index recorded in the buffer by a value of one (“1”) each time a non-zero data element is identified.

At operation 240, the electronic device 900 may obtain data corresponding to the obtained data index. For example, the electronic device may obtain a value corresponding a non-zero data element based on the obtained data index. The electronic device 900 may have determined an index of a non-zero data element in the data array using pointer and offset information in the traversal direction in the previous step (e.g., at operation 230), and may search for a corresponding value in the data array based on the index. For example, the electronic device 900 may retrieve a value stored at a specific index position in the data array using a memory controller of a central processing unit (CPU) or a GPU.

FIG. 3 is a diagram schematically illustrating a CSR according to an embodiment.

Referring to FIG. 3, the electronic device 900 may store a matrix in a data structure having the CSR format. The CSR format may reduce memory usage by storing only non-zero values in the matrix, and managing row and column information separately. The electronic device 900 may store data based on each row of the matrix, and may additionally record column information and a starting position of the row, in which corresponding data exists.

In the CSR format, a structure of a matrix may be compressed by storing a data array, column offsets, and row pointers. The electronic device 900 may analyze the matrix illustrated in FIG. 3 to organize data in the following manner. In the data array, non-zero elements of the matrix may be stored in a row-major order. The column offsets may store a column index, in which each data element is located. The row pointers may store an index, from which a non-zero value of each row begins.

For example, in FIG. 3, the row pointers are [0, 3, 4, 6, 7] and may be determined by the following rule. Because data in a zeroth (“0th”) row 310 starts at the zeroth position and there are three data elements in the zeroth row 310, a starting index of the first row 311 may have an index value of three (“3”). Because the data in the first row 311 starts at the index value of three (“3”) and there is one data element in the first row 311, a starting index of the second row 312 may have an index value of four (“4”). Because data in the second row 312 starts at the index value of four (“4”) and there are two data elements in the second row 312, a starting index of the third row 313 may have an index value of six (“6”). A position at which the data of the last row ends may be stored as an index value of seven (“7”).

In addition, the column offsets may be expressed as a vector [0, 2, 3, 1, 2, 3, 3], which may be determined as follows. In the zeroth row 310, a value of “a” may be located in a zeroth column 320, a value of “b” may be located in a second column 322, and a value of “c” may be located in a third column 323. In the first row 311, a value of “d” may be located the first column 321. In the second row 312, a value of “e” may be located in a second column 322, and a value of “f” may be located in a third column 323. In the third row 313, a value of “g” may be located in a third column 323.

Therefore, the data array may be represented as a vector [a, b, c, d, e, f, g], and the non-zero values of the non-zero data elements included in the vector may be stored in units of rows.

The electronic device 900 may reduce memory usage by storing, using the CSR format, only non-zero data (e.g., only values of non-zero data elements). As the sparsity of a matrix increases, (e.g., as the proportion of non-zero values to zero values decreases), the compression ratio may be improved.

The electronic device 900 may reduce bitwidth by storing relative column positions ( e.g., column differences) instead of the column offsets. In general, instead of storing the column offsets directly, storing a difference from a previous column index may allow data to be compressed more efficiently. For example, column information of the matrix may be stored using a small bitwidth of about four bits, thereby reducing the memory usage.

In addition, the row pointer may have a size that is one more than the number of rows in the entire matrix, and may therefore store a relatively small amount of data. Accordingly, the electronic device 900 may optimize matrix traversal speed by applying a process of storing pointers and indices separately.

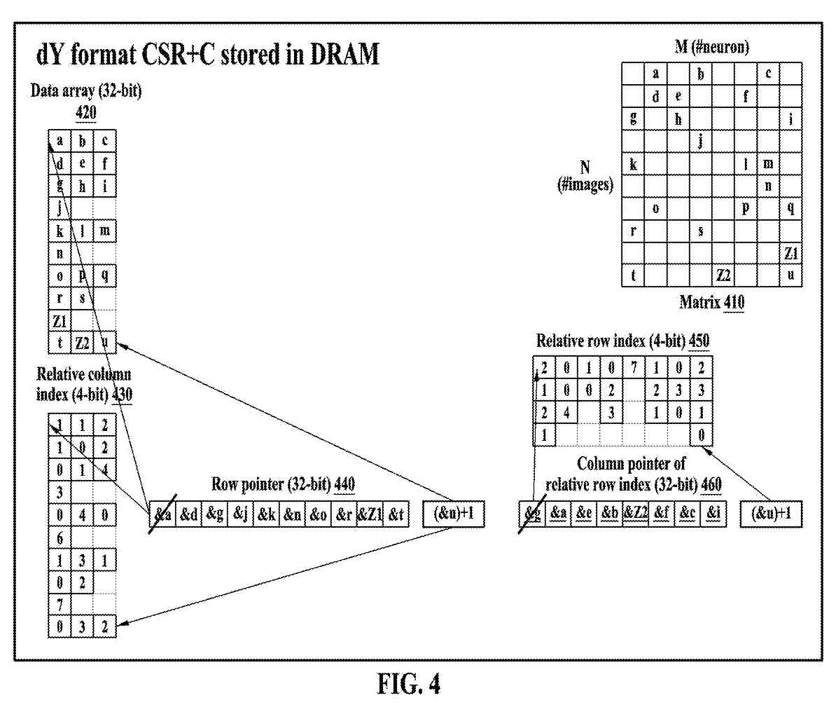

FIG. 4 is a diagram schematically illustrating a matrix compression process according to an embodiment.

The description provided with reference to FIGS. 1-3 may apply to FIG. 4, and any repeated, redundant, or duplicative description related thereto may be omitted.

Referring to FIG. 4, the electronic device 900 may compress a matrix 410 using a matrix compression process (e.g., CSR+CSC).

A data structure based on the CSR format may include a data array 420, a relative column index (or column offset) 430, and a row pointer 440.

For example, the electronic device 900 may sequentially store values of non-zero data elements in the data array 420 structure. The electronic device 900 may sequentially arrange, in a memory space, non-zero data included in the matrix 410.

The electronic device 900 may store the column position of each data element using the relative column index 430. The relative column index 430 may compress data by storing only the difference (or offset) from a previous column index value instead of an absolute column index. As illustrated in FIG. 4, the values [a-b-c-d-e-f-g-h-i-j-k-l-m-n-o-p-q-r-s-Z1-t-Z2-u] corresponding to non-zero elements included in the matrix 10 may be represented or stored using relative column indices (or offsets) [1-1-2-1-0-2-0-1-4-3-0-4-0-6-1-3-1-0-2-7-0-3-2].

The electronic device 900 may store the row pointer 440 to indicate a position at which a non-zero element in each row begins within the data array 420. The pointer value of the first row may always be a value of zero (“0”) and therefore may not be stored separately, and the next position of a last row may be set equal to a total number of non-zero data elements.

Based on the CSR format, a relative row index 450 in the CSC format and a column pointer 460 of the relative row index 450 may be additionally included. The relative row index 450 may store relative position values corresponding to the non-zero elements included in the matrix 10 in the order [g-k-r-t-a-d-o-e-h-b-j-s-Z2-f-l-p-c-m-n-i-q-Z1-u] as opposed to the order used for the relative column index 430 described above. Therefore, the non-zero elements included in the matrix 10 may be represented or stored using relative row indices (or offsets) [2-1-2-1-0-0-4-1-0-0-2-3-7-1-2-1-0-3-0-2-3-1-0].

For convenience, the data array 420, the relative column index 430, and the relative row index 450 of FIG. 4 are each illustrated as a data structure for each of rows or each of columns, but embodiments are not limited thereto. For example, in some embodiments, each of the data array 420, the relative column index 430, and the relative row index 450 may be a data structure sequentially arranged in a single column.

The electronic device 900 may store the relative row index 450 using a 4-bit size. The column pointer 460 of the matrix may be stored using separate 32-bit pointers.

The electronic device 900 may perform both row-wise traversal and column-wise traversal by combining the CSR and CSC approaches. Because the CSR approach may be optimized for row-wise access, and the CSC approach may be optimized for column-wise access, the electronic device 900 may optimize matrix operations by combining advantages of the two approaches.

In addition, the electronic device 900 may optimize a storage space by allocating only as much bitwidth as needed by the data array 420. For example, when value ranges of the relative column index 430 and the relative row index 450 are limited, the relative column index 430 and the relative row index 450 may be stored in either a 4-bit size or an 8-bit size, thereby achieving a higher compression ratio than the a 32-bit unit storage process.

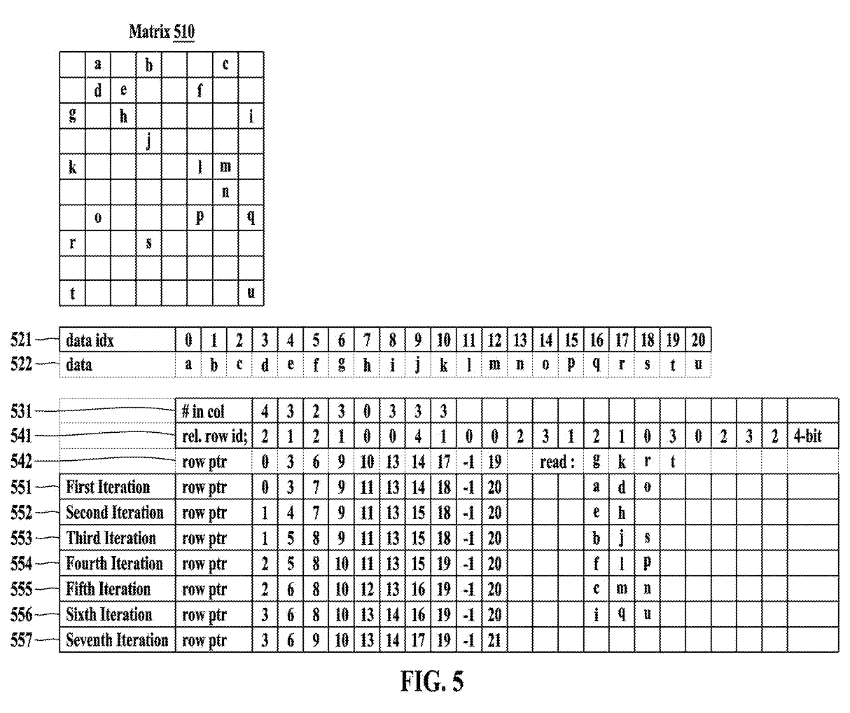

FIG. 5 is an example diagram illustrating a matrix traversal process according to an embodiment.

The description provided with reference to FIGS. 1-4 may apply to FIG. 5, and any repeated, redundant, or duplicative description related thereto may be omitted.

Referring to FIG. 5, a matrix 510 may be compressed according to a matrix compression process to obtain a compressed matrix corresponding to the matrix 510. According to embodiments, the compressed matrix may include a data array which includes data indices 521 (illustrated as “data idx”) and data 522. The compressed matrix may also include a column pointer531 (illustrated as “# in col”), a relative row index 541 (illustrated as “rel.row idx”), and a row pointer 542 (illustrated as “row ptr”). FIG. 5 may illustrate an example of a process of performing row-wise traversal.

Each column pointer value may indicate a number of data elements (e.g., non-zero data elements) included in a corresponding column (e.g., # in col), and each row pointer value may indicate an index at which a first element is located in a current row.

First, the electronic device 900 may determine a position in the current row at which the data begins by copying the row pointer to the buffer. Thereafter, the number of non-zero values or non-zero data elements (e.g., four (“4”)) included in the corresponding column may be sequentially read from the relative row index (e.g., the rel.row idx 541).

For example, relative row index values representing relative row positions of non-zero data elements in a first column may be [2, 1, 2, 1]. Here, because the relative position value may use a [-1] format, the actual row positions may be converted to [2, 4, 7, 9].

The electronic device 900 may find an index corresponding to the row positions [2, 4, 7, 9] in the row pointer (e.g., the row ptr 542) and read corresponding values from the data array. For example, when reading the second, fourth, seventh, and ninth indices from the row pointer (e.g., the row ptr 542), data index values of six (“6”), ten (“10”), seventeen (“17”), and nineteen (“19”) may be confirmed in the data array, and data values (g, k, r, t) pointed to by the corresponding data indices may be read.

Here, the electronic device 900 may need to increase the row pointer value by a value of one (“1”) for next data each time the electronic device 900 a data index value (e.g., when the electronic device 900 reads the data index values of six (“6”), ten (“10”), seventeen (“17”), and nineteen (“19”)) from the buffer. This may be an action to update a next data position in the column direction when data is read one by one from the same row. Accordingly, the data index values of six (“6”), ten (“10”), seventeen (“17”), and nineteen (“19”) may be updated to data index values of seven (“7”), eleven (“11”), eighteen (“18”), and twenty (“20”) in a first iteration 551.

By iterating this process and reading data one column at a time, data may be read sequentially even in a compressed matrix format. For example, data may be read in a first iteration 551, followed by a second iteration 552, followed by a third iteration 553, followed by a fourth iteration 554, followed by a fifth iteration 555, followed by a sixth iteration 556, followed by a seventh iteration 557. Therefore, in the example illustrated in FIG. 5, data may be read in the order g-k-r-t-a-d-o-e-h-b-j-s-f-l-p-c-m-n-i-q-u.

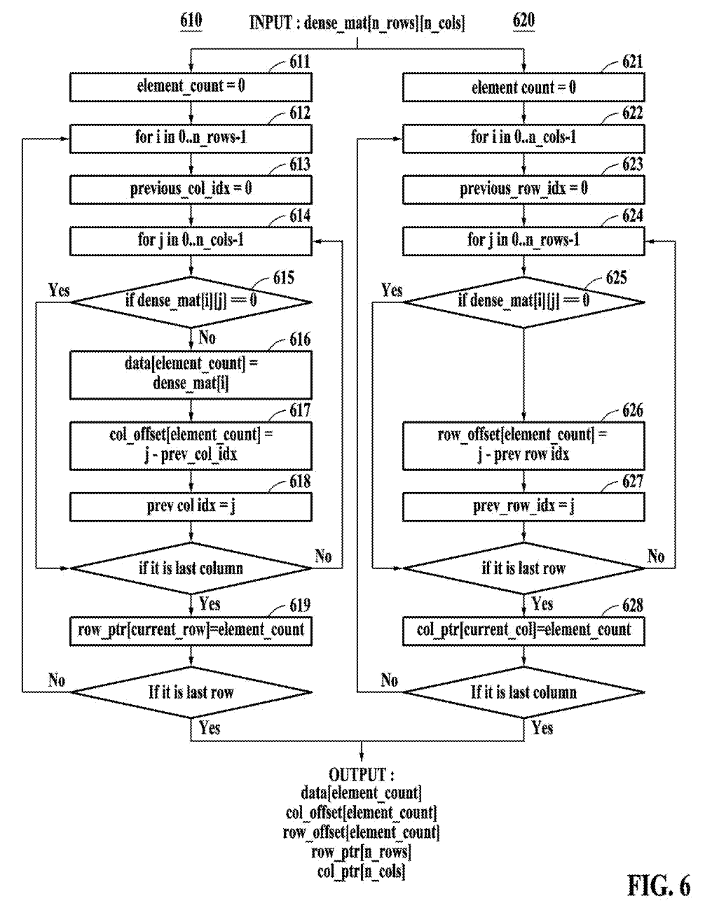

FIG. 6 is a flowchart illustrating a matrix compression algorithm according to an embodiment.

The description provided with reference to FIGS. 1-5 may apply to FIG. 6, and any repeated, redundant, or duplicative description related thereto may be omitted.

A first flowchart 610 of FIG. 6 may be similar to a general CSR conversion approach, and the electronic device 900 may extract only non-zero elements while traversing a dense matrix, and may store the extracted non-zero elements in a compressed format (e.g., as a compressed matrix). The electronic device 900 may first initialize an element count (element_count) to 0 at operation 611, and traverse rows (i) from i=0 to i=n_rows-1 (where n_rows denotes a number of the rows) at operation 612. The electronic device 900 may reset a previous column index (previous_col_idx) to a value of zero (“0”) at operation 613 each time a row changes to compute a column (col) interval from a non-zero element found first in that row.

The electronic device 900 may traverse columns (j) within each of the rows (i) from j=0 to j=n_cols-1 (where n_cols denotes a number of the columns) at operation 614, and when a non-zero value is found (e.g., "No" condition achieved) in the matrix (dense_mat[i][j]) at operation 615, the electronic device 900 may perform the following operations.

At operation 616, the electronic device 900 may store a value dense_mat[i][j], which is a non-zero value, in the data array (data[element_count]) (where element_count denotes a current element count) . At operation 617, the electronic device 900 may store a difference between a current column (j) and a previous column index (previous_col_idx) in a column offset (col_offset[element_count]). This may be a way to record relative column positions. At operation 618, the electronic device 900 may update previous_col_idx to the current column (j).

The electronic device 900 may prepare to store a next non-zero element by increasing the element_count by a value of one (“1”).

When reaching a last row, the electronic device 900 may store a total number of non-zero elements (element_count) recorded by the time point in row_ptr[current_row] of a corresponding row (current_row) at operation 619. By this operation, it may be possible to manage up to which data of each of the rows has been allocated, and when the last row has been reached, an entire flow may be terminated before moving on to a next row.

A second flowchart 620 of FIG. 6 may be similar to the CSC conversion approach, and the electronic device 900 may extract non-zero elements based on the column. The electronic device 900 may initialize element_count to 0 at operation 621, and may traverse the column (j) from 0 to n_cols-1 at operation 622. The electronic device 900 may reset a previous row index (previous_row_idx) to a value of zero (“0”) at operation 623 each time a column changes to compute a row (row) interval from a non-zero element found first in that column.

In column-wise traversal, each of the rows i within each of the columns j may be traversed from i=0 to i=n_rows-1 at operation 624, and when there is a non-zero value (e.g., "No" condition achieved) in dense_mat[i][j] at operation 625, the electronic device 900 may perform the following operations.

At operation 626, the electronic device 900 may store a difference between a current row (j) and previous_row_idx in a row offset (row_offset[element_count]). This may indicate a relative row interval between adjacent elements within that column. At operation 627, the electronic device 900 may update previous_row_idx to the current row (j).

The electronic device 900 may prepare to store a next non-zero element by increasing the element_count by 1.

When reaching the last row, the electronic device 900 may identify up to which non-zero element has been allocated by writing element_count to col_ptr[current_col] corresponding to a current column (current_col) at operation 628. When the iteration ends in the last column, the entire conversion process may be completed.

When the conversion is completed, the electronic device 900 may finally output a non-zero data array (data), a column offset (col_offset), a row offset (row_offset), a row pointer (row_ptr), a column pointer (col_ptr), and the like. According to embodiments, the non-zero data array (data), a column offset (col_offset), a row offset (row_offset), a row pointer (row_ptr), a column pointer (col_ptr), and the like, may be referred to as a compressed matrix corresponding to the dense matrix, or a compressed representation of the dense matrix (e.g., a result obtained by compressing the dense matrix). For convenience, the offset may be stored by subtracting a value of one (“1”) to keep the offset a number greater than or equal to a value of one (“1”). For example, when an actual column (or row) index difference is k, k-1 may be written to an offset array to generate a non-zero relative value. When a maximum interval exceeds a range that may be expressed by a given bit length, the electronic device 900 may maintain compatibility by additionally inserting a value of zero ("0") and concatenating and recording the remaining offset as necessary.

The electronic device 900 may store, in row_ptr or col_ptr, an index at which each row (or column) begins and an index subsequent to a last element to determine a range in which the data for each row or column continues in a compressed structure. The last element may be set to be equal to a total number of non-zero elements, so that traversal may be performed within the range.

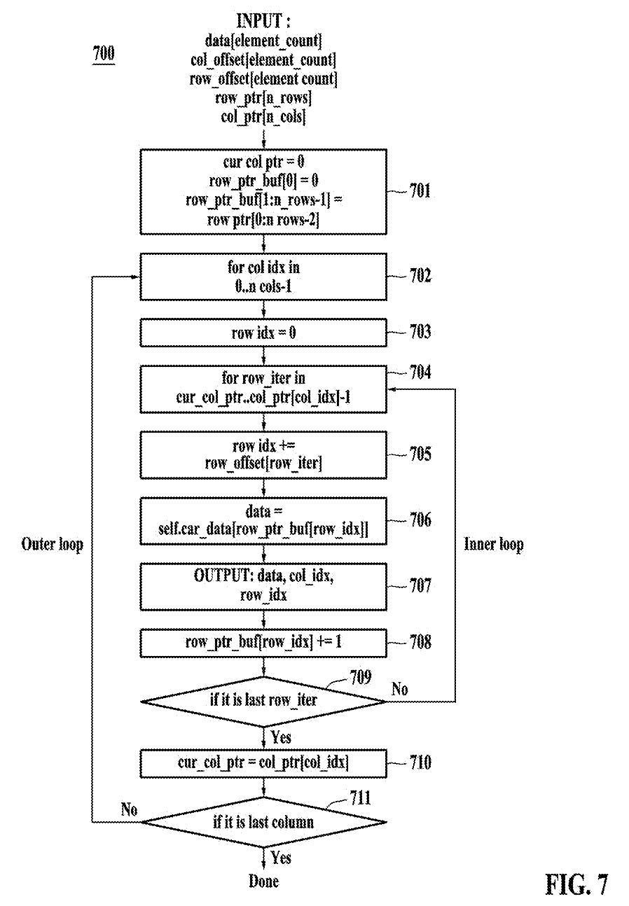

FIG. 7 is a flowchart illustrating a row-wise traversal algorithm for a matrix, according to an embodiment.

The description provided with reference to FIGS. 1-6 may apply to FIG. 7, and any repeated, redundant, or duplicative description related thereto may be omitted.

Referring to FIG. 7, a third flowchart 700 is illustrated, which is a flowchart of row-wise traversal. The electronic device 900 may receive, as an input, a non-zero data array (data[element_count]), a column offset (col_offset[element_count]), a row offset (row_offset[element_count]), a row pointer (row_ptr[n_rows]), and a column pointer (col_ptr[n_cols]), which may be referred to as a compressed matrix or a compressed representation of a matrix (e.g., a result obtained by compressing a matrix). In some embodiments, the input received by the electronic device 900 in FIG. 7 may correspond to the output generated in the example shown in FIG. 6 (e.g., the compressed matrix corresponding to the dense matrix), but embodiments are not limited thereto. The electronic device 900 may reference a column pointer, a row pointer, and a row index together to read data in the row direction.

The electronic device 900 may first initialize a current column pointer (cur_col_ptr) to a value of zero (“0”) and set a first element of a row pointer buffer (row_ptr_buf) to a value of zero (“0”) at operation 701. Subsequently, the electronic device 900 may copy a value of row_ptr[0..n_rows-2] to a row_ptr_buf[1..n_rows-1] section. Converted row_ptr in the row_ptr_buf may indicate a starting index of a next row, and may be prepared separately to track the position in a current row when traversing. The electronic device 900 may clearly distinguish an index at which a first row begins by initializing row_ptr_buf[0] to 0.

The electronic device 900 may sequentially increase a column index (col_idx) from col_idx=0 to col_idx=n_cols-1 in an outer loop beginning at operation 702, and traverse each column.

The electronic device 900 may initialize a row index (row_idx) to a value of zero (“0”) each time col_idx changes to prepare to recalculate row positions at operation 703. The electronic device 900 may determine the number of non-zero data elements contained or included in a current column (e.g., a column corresponding to a current value of col_idx) by checking a value of a col_ptr[col_idx] value corresponding to the current column. For example, when a value of col_ptr[col_idx] is ten (“10”), the electronic device 900 may recognize that ten values of row_offset are allocated to the corresponding column.

The electronic device 900 may sequentially increase a row iteration (row_iter) from cur_col_ptr to col_ptr[col_idx]-1 in an inner loop beginning at operation 704, and may check a row_offset[row_iter] value for each row_iter. The electronic device 900 may determine a row position to actually access by accumulating row_offset[row_iter] to row_idx at operation 705.

After determining the row_idx, the electronic device 900 may retrieve actual data from a data array by referencing a value recorded in row_ptr_buf[row_idx] at operation 706. For example, when a value of row_ptr_buf[row_idx] is seven (“7”), the electronic device 900 may read the element at a data[7] position. The read data, the current column (e.g., a column corresponding to a current value of col_idx), and row_idx information may be exported as a single output (OUTPUT) at operation 707. Through this process, the electronic device 900 may sequentially check data contained or included in a particular column in the row direction and identify which row and which column the data is positioned in the original matrix.

After reading data, the electronic device 900 may prepare a next data index to be accessed by increasing the value of row_ptr_buf[row_idx] by a value of one (“1”) at operation 708. The row_ptr_buf may serve as a buffer for a converted row pointer and may dynamically update the number of elements that have already been read in each row. When row_iter reaches col_ptr[col_idx]-1 at operation 709, the electronic device 900 may terminate an internal iteration for the current column and update cur_col_ptr to col_ptr[col_idx] at operation 710. Through this process, the electronic device 900 may define a position to start reading the row_offset when traversing a next column (col_idx+1) (e.g., returning to operation 702 for a next iteration of the outer loop).

The electronic device 900 may determine whether the traversal has been completed up to a last column (col_idx == n_cols-1) at operation 711, and when all columns have been traversed, may terminate the algorithm with a “Done” state. During the traversal process, the electronic device 900 may check an actual data value, a column index (col_idx), and a row index (row_idx) for each element together and may thus perform row-wise access within the matrix.

The electronic device 900 may perform row-wise data traversal for all columns by iterating this process. In this way, the electronic device 900 may perform row-wise traversal within a converted matrix based on the flowchart shown in FIG. 7, and may efficiently obtain the non-zero data using information such as column offset, row offset, row_ptr_buf, and col_ptr. Accordingly, the electronic device 900 may reconstruct at least a portion of a decompressed matrix corresponding to the compressed matrix.

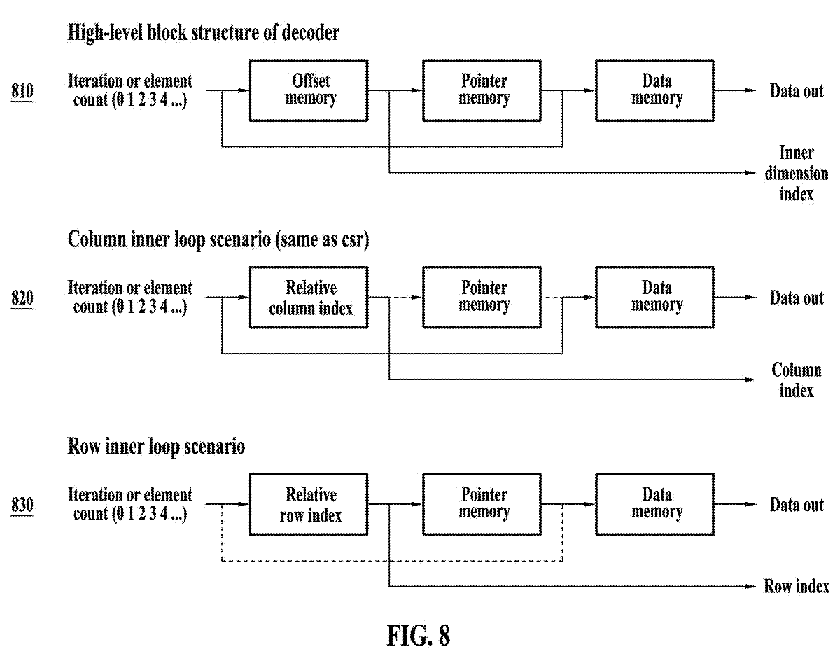

FIG. 8 is a block diagram schematically illustrating an electronic device performing a traverse operation, according to an embodiment.

The description provided with reference to FIGS. 1-7 may apply to FIG. 8, and any repeated, redundant, or duplicative description related thereto may be omitted.

Referring to FIG. 8, a structure in which the electronic device 900 performs column-wise and row-wise data traversal processing is schematically illustrated. The electronic device 900 may include an offset memory, a pointer memory, and a data memory that perform different roles to efficiently traverse and operate a matrix.

A first block diagram 810 of FIG. 8 may represent a high-level block structure of a decoder. The electronic device 900 may load data from the offset memory and, based on the data, refer to the pointer memory to retrieve actual data from the data memory.

The electronic device 900 may first load data from the offset memory to check relative position information of data to currently traverse. An offset may represent a relative position difference between non-zero data elements within a matrix, which may reduce memory usage compared to an approach that includes storing direct addresses.

The electronic device 900 may determine, using pointer memory, a starting position at which data of a particular row or column is stored. The pointer memory may function to store a position at which a particular row or column begins in a data array, allowing positions of the data to be quickly found during row-wise or column-wise traversal.

The electronic device 900 may read actual data (e.g., a value of a non-zero data element) from the data memory by using an address determined by the pointer memory and may output final data.

Using this structure, the electronic device 900 may configure an iteration structure by using an inner dimension index and traverse the data in a desired direction (e.g., row-wise or column-wise).

A second block diagram 820 may represent an internal loop structure that performs column-wise traversal. This may be same as, or similar to, a traversal structure corresponding to the CSR approach.

The electronic device 900 may retrieve data from a relative column index and transfer the data to the pointer memory. The relative column index may be used to determine a column position of the current data.

The electronic device 900 may determine a position at which data elements contained or included in the current column are stored within the data memory by referencing the pointer memory.

Based on the address obtained by the pointer memory, the electronic device 900 may read data from the data memory and finally output the data (e.g., a value of a non-zero data element).

In this process, the electronic device 900 may sequentially read the data and may thus output a column index while accumulating relative column indices. In addition, when traversing the data, an address of the data memory may be determined based on a count.

A third block diagram 830 may represent an internal loop structure that performs row-wise traversal. This may include mixing the CSC structure with the CSR approach, and the electronic device 900 may traverse the data based on the row pointer.

A relative row index may indicate how far apart data elements in a same column are in the row direction within a particular column.

The electronic device 900 may determine a position at which data elements contained or included in a particular row are stored within the data memory by referencing the row pointer. Based on the address determined by the row pointer, the electronic device 900 may read data from the data memory and output the final data.

In this process, the electronic device 900 may retrieve a sequential data position of the row from the pointer memory and use the sequential data position of the row as an address of the data memory. In addition, during the traversal process, the electronic device 900 may increase pointer values by a value of one (“1”) to track a position of subsequent data.

The hardware structure of FIG. 8 may be used to divide memory according to the bitwidth. The pointer memory may only store as many data elements as the number of rows or columns and may be configured to be relatively small in size. The offset memory may have a size equal to the number of data elements, but a bit length may be limited to four to eight bits, so the size thereof may be reduced compared to the data memory. The data memory may store data values that are actual targets of operations and may be managed in cache or high-speed memory considering operation performance.

FIG. 9 is a block diagram illustrating an electronic device according to an embodiment.

The description provided with reference to FIGS. 1-8 may apply to FIG. 9, and any repeated, redundant, or duplicative description related thereto may be omitted.

Referring to FIG. 9, an electronic device 900 may include a processor 930, a memory 950, and an output device 970 (e.g., a display). The processor 930, the memory 950, and the output device 970 may be connected to one another via a communication bus 905. The electronic device 900 may include, for operating the electronic device 900, the processor 930 for performing at least one of the processes described above and/or an algorithm corresponding to at least one of the processes.

The output device 970 may display an operation progress result provided by the processor 930. The output device 970 may be the same device as a display included in the electronic device 900. In addition, the output device 970 may be embedded into the electronic device 900 to display the operation progress result or may be an external display device.

The memory 950 may store data elements related to the matrix compression process and traversal process performed by the processor 930. Furthermore, the memory 950 may store a variety of information generated in the processing process of the processor 930 described above. In addition, the memory 950 may store a variety of data and programs. The memory 950 may include, for example, a volatile memory or a non-volatile memory. The memory 950 may include a high-capacity storage medium, such as a hard disk, to store a variety of data.

In addition, the processor 930 may perform at least one of the processes described with reference to FIGS. 1-9 and/or an algorithm corresponding to at least one of the processes. In the above-described process, the processor 930 may be a hardware-implemented data processing device having a circuit that is physically structured to execute desired operations. The desired operations may include, for example, code or instructions in a program. The processor 930 may be implemented as, for example, a CPU, a GPU, or a neural processing unit (NPU). For example, a hardware-implemented electronic device 900 may include, for example, a microprocessor, a CPU, a processor core, a multi-core processor, a multiprocessor, an application-specific integrated circuit (ASIC), and an FPGA.

The processor 930 may execute a program and control the electronic device 900. Program code to be executed by the processor 930 may be stored in the memory 950.

The instructions may, when executed by the processor 930, cause the electronic device 900 for performing matrix compression to identify non-zero data elements in a matrix and generate a data array in which corresponding data elements are arranged sequentially, generate a pointer corresponding to each of rows or each of columns of the matrix and designate, to the pointer, a position in the matrix or the number of non-zero data elements included in a corresponding row or a corresponding column, wherein the pointer includes at least one of a row pointer and a column pointer, and generate an offset that indicates a relative position between the non-zero data elements and designate, to the offset, a relative index to be used when traversing the matrix in a row direction or the column direction, wherein the offset comprises at least one of a row offset or a column offset.

The instructions may, when executed by the processor 930, cause the electronic device 900 that performs matrix traversal to obtain a data array, obtain a pointer and an offset that store information regarding the data array, obtain a data index corresponding to non-zero data in the data array based on an offset corresponding to a traversal direction, a pointer corresponding to the traversal direction, and a pointer corresponding to a direction other than the traversal direction, and obtain data corresponding to the obtained data index.

The embodiments described herein may be implemented using a hardware component, a software component, and/or a combination thereof. For example, a processing device may be implemented using one or more general-purpose or special-purpose computers, such as, for example, a processor, a controller, an arithmetic logic unit (ALU), a digital signal processor (DSP), a microcomputer, an FPGA, a programmable logic unit (PLU), a microprocessor, or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the processing device is described as singular. However, one of ordinary skill in the art will appreciate that a processing device may include multiple processing elements and/or multiple types of processing elements. For example, the processing device may include a plurality of processors, or a single processor and a single controller. In addition, different processing configurations are possible, such as one including parallel processors.

Software may include a computer program, a piece of code, instructions, or combinations thereof, to independently or collectively instruct or configure the processing device to operate as desired. Software and/or data may be embodied permanently or temporarily in any type of machine, component, physical or virtual equipment, computer storage medium or device, or in a propagated signal wave for the purpose of being interpreted by the processing device or providing instructions or data to the processing device. The software may also be distributed over network-coupled computer systems so that the software is stored and executed in a distributed fashion. The software and data may be stored in a non-transitory computer-readable recording medium.

The processes according to the embodiments may be recorded in non-transitory computer-readable media including program instructions to implement various operations of the embodiments. The media may also include the program instructions, data files, data structures, and the like alone or in combination. The program instructions recorded on the media may be those specially designed and constructed for the purposes of examples, or they may be of the kind that is well known and available to one of ordinary skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as optical disks; and hardware devices that are specially configured to store and perform program instructions, such as read-only memory (ROM), random-access memory (RAM), flash memory, and the like. Examples of program instructions include both machine code, such as those produced by a compiler, and files containing high-level code that may be executed by the computer using an interpreter.

Although some embodiments are described above with reference to a limited number of drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order and/or if components in a described system, architecture, device, or circuit are combined in a different manner and/or replaced or substituted by other components or their equivalents.

Therefore, other implementations, other embodiments, and equivalents to the claims are also within the scope of the following claims.

What is Claimed is:

1. A method of storing a compressed matrix, the method comprising:
obtaining an input matrix comprising a plurality of data elements;
identifying a plurality of non-zero data elements in the input matrix and generating a data array in which the plurality of non-zero data elements are arranged sequentially;
generating a pointer corresponding to each row from among a plurality of rows included in the input matrix, or corresponding to each column from among a plurality of columns included in the input matrix;
designating, to the pointer, a position in the input matrix or a number of non-zero data elements included in a corresponding row from among the plurality of rows, or included in a corresponding column from among the plurality of columns, wherein the pointer comprises at least one of a row pointer and a column pointer;
generating an offset that indicates a relative interval between the plurality of non-zero data elements, and designating, to the offset, a relative index for traversing the input matrix in a row direction or a column direction, wherein the offset comprises at least one of a row offset and a column offset;
generating a compressed matrix corresponding to the input matrix based on the data array, the pointer, and the offset; and
storing the compressed matrix in at least one memory.

2. The method of claim 1, wherein the offset comprises a predetermined bitwidth.

3. The method of claim 2, further comprising:
based on an interval between adjacent non-zero data elements in the input matrix exceeding a range that is capable of being expressed using the predetermined bitwidth, inserting a value of zero (“0”) to the offset .

4. The method of claim 1, wherein the pointer comprises information regarding a data index assigned to each non-zero data element, and
wherein the information regarding the data index comprises:
for the each row or the each column, information indicating an initial data index corresponding to the each row or the each column, and a final data index corresponding to the each row or the each column.

5. The method of claim 1, wherein the storing of the compressed matrix comprises:
storing the pointer in a pointer memory corresponding to the pointer;
storing the offset in an offset memory corresponding to the offset; and
placing the data array in a data memory separate from the pointer memory and the offset memory.

6. A method of traversing a compressed matrix, the method comprising:
obtaining a data array corresponding to a compressed matrix from at least one memory;
obtaining, from the at least one memory, a pointer and an offset corresponding to the compressed matrix, wherein the pointer comprises at least one of a row pointer and a column pointer, and wherein the offset comprises at least one of a row offset and a column offset;
obtaining a data index corresponding to a non-zero data element included in the data array based on an offset corresponding to a traversal direction, a pointer corresponding to the traversal direction, and a pointer corresponding to a direction different from the traversal direction;
obtaining a value corresponding to the non-zero data element based on the data index; and
reconstructing at least a portion of a decompressed matrix corresponding to the compressed matrix based on the value.

7. The method of claim 6, further comprising:
based on determining that the data index corresponding to the non-zero data element in the data array is obtained, updating a pointer value corresponding to the data index.

8. The method of claim 6, further comprising:
after identifying the data index based on a pointer corresponding to the traversal direction, determining a position of a corresponding data element in the decompressed matrix by referencing the offset corresponding to the traversal direction according to the data index.

9. The method of claim 7, wherein the pointer value is updated by incrementing a corresponding data index for each iteration such that the pointer corresponding to the traversal direction subsequently indicates a next non-zero data element included in the data array.

10. The method of claim 9, wherein the pointer value is updated by storing a current index of a corresponding pointer in a separate buffer, and increasing a value stored in the separate buffer by a value of one (“1”) based on an index corresponding to non-zero data being identified.

11. An electronic device configured to perform at least one of matrix compression and matrix traversal, the electronic device comprising:
one or more processors; and
memory configured to store instructions which, when executed by the one or more processors, individually or collectively, cause the electronic device to:
obtain an input matrix comprising a plurality of data elements;
identify a plurality of non-zero data elements in the input matrix and generate a data array in which the plurality of non-zero data elements are arranged sequentially;
generate a pointer corresponding to each row from among a plurality of rows included in the input matrix, or corresponding to each column from among a plurality of columns included in the input matrix,
designate, to the pointer, a position in the input matrix or a number of non-zero data elements included in a corresponding row from among the plurality of rows, or included in a corresponding column from among the plurality of columns, wherein the pointer comprises at least one of a row pointer and a column pointer; and
generate an offset that indicates a relative interval between the plurality of non-zero data elements, and designate, to the offset, a relative index for traversing the input matrix in a row direction or a column direction, wherein the offset comprises at least one of a row offset and a column offset,
generate a compressed matrix corresponding to the input matrix based on the data array, the pointer, and the offset; and
store the compressed matrix in at least one memory.

12. The electronic device of claim 11, wherein the offset comprises a predetermined bitwidth.

13. The electronic device of claim 12, wherein the instructions, when executed by the one or more processors, individually or collectively, further cause the electronic device to:
based on an interval between adjacent non-zero data elements in the input matrix exceeding a range that is capable of being expressed using the predetermined bitwidth, inserting a value of zero (“0”) to the offset .

14. The electronic device of claim 11,
wherein the pointer comprises information regarding a data index assigned to each non-zero data elements, and
wherein the information regarding the data index comprises:
for the each row or the each column , information indicating an initial data index corresponding to the each row or the each column, and a final data index corresponding to the each row or the each column.

15. The electronic device of claim 11, wherein the instructions, when executed by the one or more processors, individually or collectively, further cause the electronic device to:
store the pointer in a pointer memory corresponding to the pointer,
store the offset in an offset memory corresponding to the offset; and
place the data array in a data memory separate from the pointer memory and the offset memory.

16. The electronic device of claim 11, wherein the instructions, when executed by the one or more processors, individually or collectively, further cause the electronic device to:
obtain the data array corresponding to the compressed matrix from the at least one memory;
obtain the pointer and the offset corresponding to the compressed matrix;
obtain a data index corresponding to a non-zero data element included in the data array based on an offset corresponding to a traversal direction, a pointer corresponding to the traversal direction, and a pointer corresponding to a direction different from the traversal direction;
obtain a value corresponding to the non-zero data element based on the obtained data index; and
reconstruct at least a portion of a decompressed matrix corresponding to the compressed matrix based on the value.

17. The electronic device of claim 16, wherein the instructions, when executed by the one or more processors, individually or collectively, further cause the electronic device to:
based on determining that the data index corresponding to the non-zero data element in the data array is obtained, a pointer value corresponding to the data index.

18. The electronic device of claim 16, wherein the instructions, when executed by the one or more processors, individually or collectively, further cause the electronic device to:
after identifying the data index based on a pointer corresponding to the traversal direction, determine a position of a corresponding data element in the decompressed matrix by referencing the offset corresponding to the traversal direction according to the data index.

19. The electronic device of claim 17, wherein the instructions, when executed by the one or more processors, individually or collectively, further cause the electronic device to:
wherein the pointer value is updated by incrementing a corresponding data index for each iteration such that the pointer corresponding to the traversal direction subsequently indicates a next non-zero data element included in the data array.

20. The electronic device of claim 19, wherein the instructions, when executed by the one or more processors, individually or collectively, further cause the electronic device to:
update the pointer value by storing a current index of a corresponding pointer in a separate buffer, and increase a value stored in the separate buffer by a value of one (“1”) based on an index corresponding to non-zero data being identified.
